(19) United States
(12) Patent Application Publication
(10) Pub. No.: US 2006/0219735 A1
(43) Pub. Date: Oct. 5, 2006

(54) Dosing device

(76) Inventors: Ian Faye, Stuttgart (DE); Frank Miller, Ilsfeld (DE)

Correspondence Address: KENYON & KENYON LLP, ONE BROADWAY, NEW YORK, NY, 10004, US

(21) Appl. No.: 10/534,108

(22) PCT Filed: Sep. 26, 2003
(86) PCT No.: PCT/DE03/03213

§ 371 Date: Apr. 12, 2006

(30) Foreign Application Priority Data
Nov. 6, 2002 (DE) 102 51 698.7

(51) Int. Cl. B67D 5/16; B05B 7/00

(52) U.S. Cl. 222/71; 222/630

(57) ABSTRACT

A dosing device (1) for liquid fuels, in particular for input into a chemical reformer in order to recover hydrogen, having at least one metering device (2) for metering fuel into a metering conduit (12) and having a nozzle body (7), adjoining the metering conduit (12), having spray discharge openings (6) which open into a metering chamber (10), the nozzle body (7) projecting with a spherical portion at the spray-discharge end into the metering chamber (10), and the spray discharge openings (6) being distributed over the spherical portion of the nozzle body (7).

### FIELD OF THE INVENTION

The present invention relates to a dosing device.

### BACKGROUND INFORMATION

In fuel-cell-assisted transport systems, so-called chemical reformers are used to recover the necessary hydrogen from hydrocarbon-containing fuels such as, for example, gasoline, ethanol, or methanol.

All the substances required by the reformer for execution of the reaction, for example air, water, and fuel, are conveyed to the reaction region ideally in a gaseous state. But because water and the fuels, for example methanol or gasoline, are preferably present in liquid form on board the transport system, they must first be heated shortly before they arrive at the reaction region of the reformer in order to evaporate them. This necessitates a pre-evaporator, a separate component, or a premixing chamber in the reformer, which are capable of making available the corresponding quantities of gaseous fuel and water vapor.

The temperature necessary for the chemical reaction in which, for example, the fuel is reformed into hydrogen (inter alia) is made available by way of a so-called catalytic burner. Catalytic burners are components that have surfaces coated with a catalyst. In these catalytic burners, the fuel/air mixture is converted into heat and exhaust gases, the resulting heat being conveyed, for example, via the enveloping surfaces and/or via the hot exhaust gas stream, to the corresponding components, such as the chemical reformer or an evaporator.

The conversion of fuel into heat is highly dependent on the size of the fuel droplets that strike the catalytic layer. The smaller the droplet size and the more uniformly the catalytic layer is wetted with the fuel droplets, the more completely the fuel is turned into heat and the higher the efficiency. The fuel is thus also converted more quickly, and pollutant emissions are reduced. Excessively large fuel droplets cause deposition on the catalytic layer and therefore slow conversion. That results, for example, in poor efficiency, especially during the cold-start phase.

Since the hydrogen is usually consumed immediately, chemical reformers must be capable of instantaneously adapting the production of hydrogen to demand, e.g., in the context of load changes or startup phases. Additional measures must be taken in the cold-start phase in particular, since the reformer is not supplying any waste heat. Conventional evaporators are not capable of instantaneously generating the corresponding quantities of gaseous reactants.

It is therefore useful to distribute the fuel through a dosing device in finely distributed form and/or with good placement onto locations and surfaces on which the fuels can properly evaporate, for example, into the reaction chamber or the premixing chamber of a reformer or catalytic burner, the internal surfaces of a cylindrical combustion chamber, or the internal enveloping surfaces of a catalytic burner. It is additionally useful to be able to select the geometry of the spray-discharged fuel in such a way that certain points or locations at which the fuel can evaporate poorly, or has a disadvantageous effect on the operating behavior of, for example, a reformer, do not come directly into contact with the injected fuel.

Apparatuses for dosing fuels into reformers are known, for example, from U.S. Pat. No. 3,971,847. Here the fuel is fed in, by metering devices relatively remote from the reformer, through long metering conduits and a single nozzle into a temperature-controlled material stream. The fuel first strikes impact panels that are disposed after the outlet opening of the nozzle and are intended to cause turbulence in and distribution of the fuel, and then enters the reaction region of the reformer through a relatively long evaporation section that is necessary for the evaporation process. The long supply conduit allows the metering device to be insulated from thermal influences of the reformer.

A particular disadvantage of the apparatuses known from the aforementioned document is the fact that because of the simple design of the nozzle and the placement of the impact panels, there is only limited capability for controlled dosing of fuel into, for example, regions of the reformer having a high level of available heat. This results in a relatively large space requirement due to the need for a long and bulky evaporation section.

Problems additionally occur during cold starting, since long and bulky evaporation sections are slow to heat up and moreover dissipate a relatively large amount of unused heat. In particular, with nozzles and impact panels disposed as disclosed in U.S. Pat. No. 3,971,847 it is not possible to wet a hollow-cylindrical inner surface or spherical recess uniformly with fuel, or to exclude specific surfaces of the hollow cylinder from being wetted with fuel. The shape of the fuel cloud resulting from the metering operation can also be only insufficiently influenced.

### SUMMARY

The dosing device according to an exemplary embodiment of the present invention has the advantage that because the nozzle body projects spherically into the metering chamber, and because the spray discharge openings are placed appropriately on the nozzle body projecting spherically into the metering chamber, the geometry of the spray-discharged fuel or the fuel cloud can be outstandingly well adapted to the circumstances prevailing in the metering chamber and the conditions arising therefrom. In particular, it is possible to wet hollow-cylindrical internal surfaces and spherical recesses uniformly with fuel.

It is additionally possible to shape the fuel cloud in such a way that a gap in the fuel cloud is formed. As a result of the exclusion of certain surfaces from being wetted with fuel, and gaps in the fuel cloud, it is possible, for example, to prevent any impingement of fuel on sensors mounted on the inner surface of the metering chamber, and to improve their accuracy.

In an exemplary embodiment of the present invention, the nozzle body is shaped in hollow-cylindrical fashion at its end facing the metering conduit. This permits particularly simple and thus cost-saving manufacture, and moreover allows a thread to be applied in this region, so that the nozzle body can advantageously be connected to the metering conduit in a particularly simple, sealed, and durable fashion.

The nozzle body may also be welded, in particular laser-welded, to the supply conduit.

According to an exemplary embodiment of the present invention, the spray discharge openings have different diameters. As a result, in particular, the fuel quantity passing through the respective spray discharge opening can be determined and can be adapted to the particular requirements.

In an exemplary embodiment of the present invention the center axes of the spray discharge openings may be placed on a common intersection point, and the intersection point may be placed on the nozzle body axis. The geometry of the fuel cloud may be adapted to particular requirements by selecting the location of the intersection point on the nozzle body axis.

Furthermore, the geometry of the fuel cloud or the spray-discharge geometry constituted by the emerging fuel streams may be adjusted and improved by asymmetrical positioning or by tilting the center axis of the spray discharge openings with respect to the nozzle body axis.

In an exemplary embodiment of the present invention, the spray-discharge geometry of the fuel and the thermal conductivity characteristics of the nozzle body may be positively influenced by reducing the wall thickness of the spherical portion of the nozzle body to a wall thickness which is less than that of the remaining portion of the nozzle body.

A fuel injection valve, such as the one used, for example, for reciprocating-piston machines with internal combustion, may be used as the metering device. The use of such valves has several advantages. For example, they permit particularly accurate open- or closed-loop control of fuel metering, in which context the metering can be controlled by way of several parameters such as pulse duty factor, clock frequency, and optionally stroke length. The dependency on pump pressure is much less pronounced than in the case of metering devices that control the volumetric flow of the fuel by way of the conduit cross section, and the dosing range is much larger.

In addition, fuel injection valves are economical, reliable components that have proven successful in many ways, are known in terms of their behavior, and are chemically stable with respect to the fuels used; this is true in particular of so-called low-pressure fuel injection valves that can be used with advantage here because of the thermal decoupling.

The metering conduit advantageously has a number of reduced-wall-thickness points that decrease the thermal conductivity of the metering conduit and can also serve as heat sinks.

The dosing device according to an exemplary embodiment of the present invention may have in the nozzle body a swirl insert having a swirl conduit for generating a swirl in the metered-in fuel or fuel/gas mixture. The mixture preparation and atomization of the fuel can thereby be further improved.

The shape of the swirl insert is may be identical to the internal geometry of the nozzle body, and the swirl insert may be disposed at a distance from the wall of the nozzle body. The velocity of the fuel or the fuel/gas mixture at the swirl insert may thereby be increased, and also easily adjusted. This may improve mixture preparation and atomization.

The swirl insert may have several swirl conduits, in which context the several swirl conduits may extend parallel or can intersect as they extend. As a result, swirl generation may easily be adapted to the properties of the fuel or the fuel/gas mixture, and the swirl intensity may be adapted in accordance with requirements.

In an exemplary embodiment of the present invention the dosing device may include an air inlet with which air or another gas can be introduced into the metering conduit. Mixture preparation may thereby be further improved, and the fuel droplet size may be further reduced. In addition, fuel or the fuel/gas mixture may thus be eliminated or cleaned out of the metering conduit, in particular during shutdown phases, for example, by blowing it out with air through the air inlet. Uncontrolled emergence of fuel or a fuel/gas mixture out of the metering conduit is thus prevented.

The multi-part construction of the dosing device makes possible economical manufacture and the use of standardized components.

### BRIEF DESCRIPTION OF THE DRAWINGS

FIG. 1 is a schematically illustration of a dosing device according to an exemplary embodiment of the present invention.

FIG. 2 is a front view of the nozzle body of FIG. 1, from a point on the nozzle body axis located between the adapter piece and nozzle body.

FIG. 3 is a side view of the nozzle body taken along section line III-III in FIG. 2.

FIG. 4 is a side view taken along section line III-III in FIG. 2 of an another exemplary embodiment of the nozzle body according to the present invention.

FIG. 5 is a perspective view of the nozzle body projecting in a hollow-cylindrical metering chamber.

FIG. 6 is a longitudinal section of a further exemplary embodiment of a nozzle body according to the present invention having a swirl insert.

FIG. 7 is a longitudinal section of a further exemplary embodiment of a nozzle body according to the present invention having a swirl insert.

### BRIEF DESCRIPTION OF THE DRAWINGS

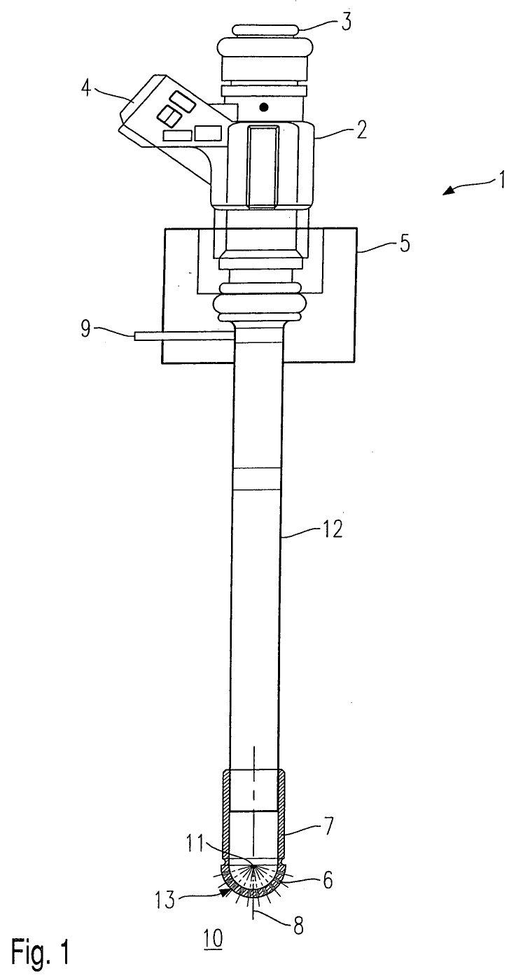

An exemplary embodiment of a dosing device 1 according to the present invention depicted in FIG. 1 is embodied in the form of a dosing device 1 for the use of low-pressure fuel injection valves. Dosing device 1 may be used for the input and atomization of fuel or a fuel/gas mixture into a metering chamber 10, shown by way of example in FIG. 5, of a chemical reformer (not depicted in further detail) in order to recover hydrogen.

Dosing device 1 encompasses a metering device 2, which in this exemplary embodiment is embodied as a low-pressure fuel injection valve, an electrical connector 4, a fuel connector 3, an adapter piece 5 for receiving metering device 2, a tubular metering conduit 12, an air inlet 9, and a nozzle body 7. Metering device 2 is tubular, fuel connector 3 being located on the upper side. Metering of fuel into metering conduit 12 is accomplished on the lower of metering device 2, adapter piece 5 connecting metering device 2 and metering conduit 12 to one another in an externally hydraulically sealed manner. Tubular air inlet 9 opens into metering conduit 12 and is connected to it in sealing fashion via a threaded connection or welded connection, such as a laser-welded connection.

The hollow-cylindrical end of nozzle body 7 facing toward metering conduit 12 encompasses the corresponding end of metering conduit 12 and is connected there in hydraulically sealed fashion to metering conduit 12 by way of a join that can be a welded or threaded connection, such as a join produced by laser welding. Alternatively thereto, it is also possible for the corresponding end of metering conduit 12 to encompass the hollow-cylindrical end, facing toward it, of nozzle body 7. Metering conduit 12 itself is made, for example, of a standardized metal tube made of stainless steel.

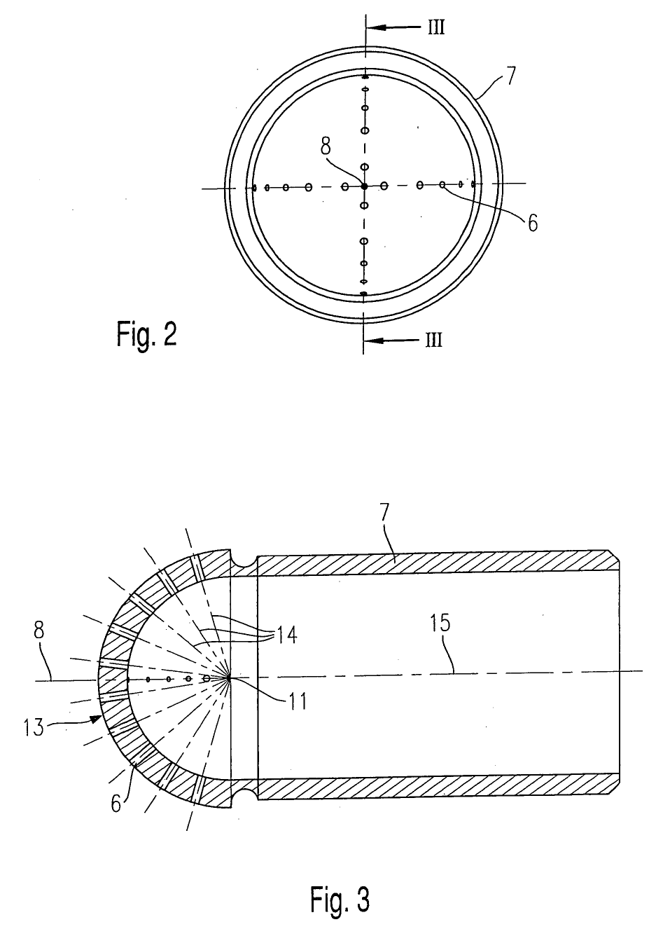

Nozzle body 7 has, in its spherical portion 13 at the spray-discharge end that is shaped like a spherical segment or semi-sphere, several (in this exemplary embodiment, twenty) spray discharge openings 6 that are depicted in more detail in FIG. 2 and FIG. 3. In the exemplary embodiment depicted here, all the spray discharge openings 6 are disposed symmetrically with respect to a nozzle body axis 8 corresponding to longitudinal axis 15 of nozzle body 7, the imaginary extensions of center axes 14 of spray discharge openings 6 extending through an intersection point 11 located on nozzle body axis 8.

Fuel, for example gasoline, ethanol, or methanol, is conveyed to metering device 2 under pressure from a fuel pump and fuel line (not depicted) through fuel connector 3. When dosing device 1 is in operation, the fuel flows downward and is metered, through the sealing fit (not depicted) located in the lower end of metering device 2, into metering conduit 12 in known fashion by opening and closing the sealing fit. Air or other gases, for example combustible residual gases from a reforming or fuel-cell process, can be conveyed, for mixture preparation, through air inlet 9 that opens laterally into metering conduit 12 near metering device 2. As it continues, the fuel is transported through metering conduit 12 to nozzle body 7 and is there metered through spray discharge openings 6 into metering chamber 10 depicted, by way of example, in FIG. 5.

FIG. 2 shows the nozzle body 7 depicted in FIG. 1, in enlarged fashion, from a point on nozzle body axis 8 located in metering chamber 10. In this view, injection openings 6 lie on two lines at right angles to one another that intersect at nozzle body axis 8, depicted here as a dot.

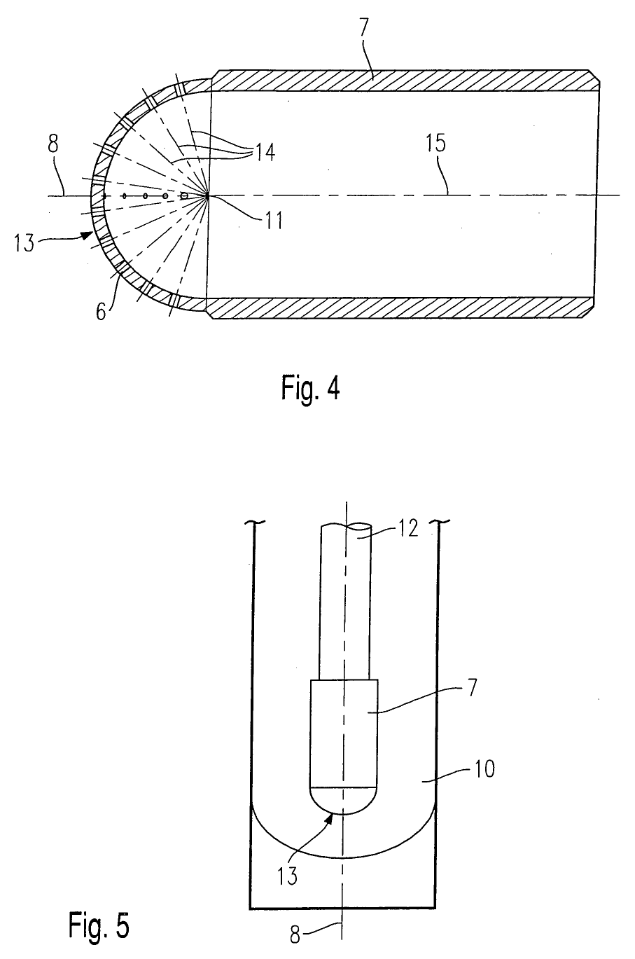

FIG. 3 is a side view of a section along line III-III through nozzle body 7 depicted in FIG. 2. It is clearly evident that in this exemplary embodiment, center axes 14 of spray discharge openings 6 intersect the common intersection point 11 located on nozzle body axis 8. In this exemplary embodiment, twenty spray discharge openings 6 are located, disposed symmetrically with respect to nozzle body axis 8, in spherically shaped portion 13 of nozzle body 7 that projects into metering chamber 10 depicted, by way of example, in FIG. 4.

FIG. 4 is a side view of a further exemplary embodiment of nozzle body 7 depicted in FIG. 2, similar to the exemplary embodiment depicted in FIG. 3. The wall thickness of spherical portion 13 of nozzle body 7 is, however, thinner as compared with the remaining wall thickness of nozzle body 7.

FIG. 5 shows nozzle body 7 mounted on supply conduit 12 and projecting into metering chamber 10. Metering chamber 10 is cylindrical, the end of metering chamber 10 that is depicted having a spherical recess. Fuel is metered through spray discharge openings 6 (not depicted in FIG. 4) into this region. As a result of the spherical conformation of nozzle body 7 at the spray-discharge end, spray discharge openings 6 are disposed in such a way that the spherical recess of metering chamber 10 is uniformly impinged upon by fuel.

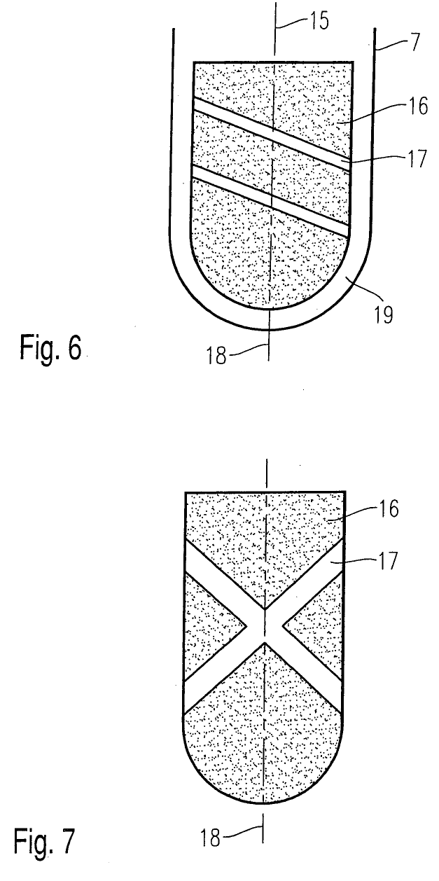

FIG. 6 is a schematic sectioned depiction of a further exemplary embodiment of a nozzle body 7 according to the present invention having a swirl insert 16 disposed in the interior of nozzle body 7. The wall of nozzle body 7 is shown merely schematically as a line, without spray discharge openings 6 that are present. Swirl insert 16 has peripherally extending swirl conduits 17 that are inclined with respect to a longitudinal swirl insert axis 18 and, thus, impart a rotation to the fuel or fuel/gas mixture flowing past. In this exemplary embodiment, longitudinal swirl insert axis 18 is coincident with center axis 15 of nozzle body 7.

The shape of swirl insert 16 is adapted both radially and, toward spherical portion 13 of nozzle body 7, to the internal shape of nozzle body 7. In this exemplary embodiment, swirl insert 16 is spaced away at a uniform distance 19, which here is, for example, less than 0.2 mm, from nozzle body 7 at the radial sides and at its spherical portion. The relatively small distance 19 results in a pressure increase in swirl conduits 17 and, thus, in better preparation.

FIG. 7 schematically depicts a further swirl insert 16 in which swirl conduits 17 do not extend in parallel fashion as in the exemplary embodiment of FIG. 6, but instead cross as they extend peripherally.

1-18. (canceled)

19. A dosing device for a liquid fuel comprising:
at least one metering device configured to meter fuel into a metering conduit; and
a nozzle body, adjoining the metering conduit, having spray discharge openings which open into a metering chamber,
wherein the nozzle body projects with a spherical portion at a spray-discharge end into the metering chamber, and the spray discharge openings are distributed over the spherical portion of the nozzle body.

20. The dosing device of claim 19, wherein the nozzle body is shaped in hollow-cylindrical fashion at an end facing the metering conduit.

21. The dosing device of claim 19, wherein the nozzle body is one of (a) sealingly thread-joined and (b) welded to the metering conduit.

22. The dosing device of claim 19, wherein the spray discharge openings have different diameters.

23. The dosing device of claim 19, wherein center axes of the spray discharge openings have a common intersection point.

24. The dosing device of claim 23, wherein the common intersection point is located on a center axis of the nozzle body.

25. The dosing device of claim 19, wherein a location of the spray discharge openings is asymmetrical with respect to a center axis of the nozzle body.

26. The dosing device of claim 23, wherein a tilt of the center axes of the spray discharge openings is asymmetrical with respect to a center axis of the nozzle body.

27. The dosing device of claim 19, wherein a wall thickness of the spherical portion of the nozzle body is less than that of a remaining portion of the nozzle body.

28. The dosing device of claim 19, wherein the at least one metering device is a fuel injection valve.

29. The dosing device of claim 28, wherein the fuel injection valve is a low-pressure fuel injection valve configured to operate with fuel pressures of up to 10 bar.

30. The dosing device of claim 19, wherein the metering conduit has at least one of (a) a reduced-wall-thickness point and (b) a reduced-wall-thickness region along an axial extent.

31. The dosing device of claim 19, wherein the nozzle body has a swirl insert having a swirl conduit, the swirl insert configured to impart a circular motion to at least one of (a) the fuel or (b) a fuel/gas mixture.

32. The dosing device of claim 31, wherein a shape of the swirl insert is identical to an internal geometry of the nozzle body.

33. The dosing device of claim 31, wherein the swirl insert is disposed in the nozzle body at a distance from a wall of the nozzle body.

34. The dosing device of claim 31, wherein the swirl insert has a plurality of swirl conduits.

35. The dosing device of claim 34, wherein the swirl conduits extend one of (a) parallel and (b) cross one another.

36. The dosing device of claim 19, wherein the dosing device has an air inlet with which a gas is introduceable into the metering conduit.

37. The dosing device of claim 21, wherein the nozzle body is laser welded to the metering conduit.

38. The dosing device of claim 19, wherein the dosing device is adapted to input the liquid fuel into a chemical reformer to recover hydrogen.
